(19) United States
(12) Patent Application Publication
(10) Pub. No.: US 2025/0095085 A1
(43) Pub. Date: Mar. 20, 2025

(54) SYSTEM FOR MAKING RISK REDUCTION PROTOCOL IN OIL AND GAS INDUSTRY TANKS

(71) Applicants: Mohammadreza HAJGHOLAMI, Antalya (TR); Nahid FARZINJOO, Antalya (TR); Hanieh TAVASSOLI, Antalya (TR); Ali SOLTANMORADI, Antalya (TR); Navid Reza GHANAT ABADI, Antalya (TR); Sohrab VAEZI, Antalya (TR)

(72) Inventors: Mohammadreza HAJGHOLAMI, Tehran (IR); Nahid FARZINJOO, Tehran (IR); Hanieh TAVASSOLI, Tehran (IR); Ali SOLTANMORADI, Tehran (IR); Navid Reza GHANAT ABADI, Tehran (IR); Sohrab VAEZI, Tehran (IR); Seyed Amirmahdi ALAVI, Tehran (IR)

(21) Appl. No.: 18/720,645

(22) PCT Filed: Dec. 21, 2021
(86) PCT No.: PCT/IB2021/062072

§ 371 Date: Jul. 14, 2024

(51) Int. Cl. G06Q 50/06; G06Q 10/0635; G06Q 10/067; G06V 20/52

(52) U.S. Cl. CPC G06Q 50/06; G06Q 10/0635; G06Q 10/067; G06V 20/52

(57) ABSTRACT

The invention system and method for making risk reduction protocol in oil and gas industry tanks based on risk management in the form of artificial intelligence use various detectors and cameras connected to the intelligent risk management system to determine the results by simulation and create related protocols for each special situation to reduce the risk effects in order to prevent personal and financial losses of the users in oil and gas industry tanks by considering all available signals as well as control structures and environmental conditions. Also the server is equipped with software related to machine learning and artificial intelligence in each case, can store the created information as new protocols in the database and send it to the central processor under similar conditions for proper use.

### TECHNICAL FIELD OF THE INVENTION

This invention relates to risk management system based on artificial intelligence to reduce the risk in oil and gas tanks using various detectors and cameras connected to the intelligent risk management system and also related to a protocol to reduce the risk effects in order to prevent personal and financial losses of the users and relates to risk analysis and calculation which is performed in 2D and 3D models.

### PRIOR ART

Every year in industrialized countries, even countries with high levels of process safety, in major hazard/incident and complex risks facilities, in the storage tanks of the oil, gas and petrochemical industries major and catastrophic accidents occur including all types of fire, explosions and releases of toxic gases. In addition to casualties that results in the loss of skilled professionals and experts in the industry, these accidents impose enormous costs on industries and storage infrastructure of the oil and gas industry and damage the environment as well as damage the reputation of the organization. Reasons of these accidents is according to researches on 242 accidents of tanks containing hazardous chemicals such as petroleum, oil products that occur over a period of 40 years, including lightning, hot work during repairs, operational errors, equipment failure, sabotage, cracks and rupture, leakage and perforation of pipes, static electricity, leap up flames, natural disasters and unstable thermal reactions. Nowadays, by applying risk reduction measures (including preventive, protective and mitigation measures) and emergency response measures to recover based on Real-time dynamic intelligent risk assessment (RDIRA) process risks of tanks, these accidents can be prevented from spreading and escalation. According to statistics collected from Journal of Loss Prevention in the process Industries 19, 80% of accidents are due to fire, 15% due to explosions and the remaining 5% are due to human errors and other parameters.

Many of these accidents can be prevented today with the development of science and the prediction of potential risks.

Risk prediction and identification is not possible for managers of tanks section without the use of software. Now, if they can identify the risk before occurring the accident, analyzing the risk is a time consuming and difficult task. This becomes even more difficult when occurring an accident because in critical situations the supervisor or manager of the tanks section must manually analyze all the side risks, the proper process performance for the tanks section and rescue workers in a manual way and declare an appropriate scenario to resolve the accident. This is very time consuming and has many errors.

By using artificial intelligence technology, which today is used only for cognition (individuals, personal protective equipment (PPE), full monitoring of the work area, etc.) in various industries, this technology can analyze the risk level by risk management based on artificial intelligence and provide the best operational scenario to reduce the risk level and prevent accidents.

The ultimate goal of protective measures is to reduce the effects of danger and injury. This goal can be associated with reducing the risk or reducing the effects of each of the risk-determining elements.

A US Patent No. US20170245806A1 granted on 9 Jun. 2020 titled “System and method for monitoring safety and productivity of physical tasks” provided Methods and systems for monitoring workplace safety and evaluating risks. The method comprising receiving signals from at least one wearable device, identifying portions of the signals corresponding to physical activities, excerpting the portions of the signals corresponding to the physical activities, and calculating risk metrics based on measurements extracted from the excerpted portions of the signals, the risk metric indicative of high risk lifting activities. In some embodiments, the computing device separately receives a second signal from a wearable second device. The computing device identifies, from the first signal and/or the second signal, an initiation time for a physical activity, such as a lifting activity performed by a wearer of the first device and the second device. The computing device then identifies a signal segment from the first signal for a time period corresponding to an initiation of a physical activity. A system implementing such a sensor may be trained using a machine learning predictive model. The accuracy of lift detection may be improved by way of machine learning algorithms. Multiple communication interfaces may provide the ability to communicate data in real time, including alerts and alarms, via a wearable device using long-term communication methods.

A U.S. Pat. No. 10,643,080 granted on 5 May 2020 titled “Artificial intelligence and image processing-based work force safety” provided method of workplace safety for an industrial processing facility includes an artificial intelligence and image processing-based work force safety system at a first time receiving image data from cameras viewing work zones including a first camera showing an individual in a first work zone. From the image data a current location of the individual is determined. A current minimum Personnel Protection Equipment (PPE) requirement is determined based on the current location by referencing a database having workplace environments with hazardous condition(s) including for the current location determining a current workplace environment having a current hazardous condition. The image data is analyzed to identify PPEs currently worn by the individual. When it is determined the individual is not currently meeting the PPE requirement by comparing the PPEs currently worn to the minimum PPE requirement, an alert is generated responsive to the unsafe condition. An application server is coupled to the control processing unit. The control processing unit is coupled to a memory that includes a stored database 134 a including reference images for various hazardous conditions and for various locations, and PPEs required for the different locations.

A US Patent No. US20190187681A1 filed on 28 Dec. 2018 titled “Methods and systems for data collection in downstream oil and gas environment with haptic feedback and continuously monitored alarm” provided Methods and systems for data collection in downstream oil and gas environment with haptic feedback and continuously monitored alarm are disclosed. A monitoring system for data collection can include a data acquisition circuit to interpret a plurality of detection values, a data analysis circuit to analyze the detection values to determine at least one of a sensor state, a process state, or a component state and determine an alarm value in response to at least one of the detection values, an analysis response circuit to perform an action in response to the at least one of the sensor state, the process state, or the component state and continuously monitor the alarm value, and a haptic user device to generate a haptic stimulation. This invention refers to a self-organizing data marketplace, for data collected by one or more data collection systems or for data from other sensors or input sources that are located in various data collection environments, such as industrial environments. In addition to data collection systems, this may include data collected, handled or exchanged by IoT devices, such as cameras, monitors, embedded sensors, mobile devices, diagnostic devices and systems, instrumentation systems, telematics systems and similar cases which can prevent the risk of damaging to user.

A Korean Patent No. KR101717560B1 granted on 17 Mar. 2017 titled “Corrosion risk management system and method” provided a corrosion risk management system and method. This invention relates to a corrosion risk assessment tool for evaluating corrosion risk of a facility; A corrosion risk rating tool for assessing a corrosion risk rating based on the corrosion risk rating evaluated by the corrosion risk assessment tool; A facility-hazard class matching tool that catalogs and correlates the corrosion hazard ratings evaluated in the corrosion hazard assessment tool with those installed in the plant; A remaining life assessment tool for assessing the remaining life of the facility; A portable terminal capable of real-time checking the corrosion risk level and the remaining life of each facility at a location where facilities are installed in the workplace; And a main server that is interlocked with the facility-hazardous level matching tool, the remaining life evaluation tool, and the portable terminal, and transmits a corrosion risk level and a remaining lifetime of each facility to the portable terminal, and a corrosion risk management system Provide a management method.

A Chinese Patent No. CN104852992B granted on 2 Nov. 2018 titled “A kind of emergent on-line intelligence system of the safety based on multi communication network and sensing equipment” provided a kind of emergent on-line intelligence systems of safety based on multi communication network and sensing equipment, belong to long-distance intelligent safety supervision equipment technical field. It is made of online monitoring and management module, safety in production cloud data center, emergency management and rescue module etc., its main feature is safety in production cloud data center input terminal is connected in parallel to online monitoring and management module, early warning analysis aid decision module. Its output end is connected in parallel to monitoring and warning module, video review intelligent control module, emergency management and rescue module, info push module. The data transfer rate being connect with monitoring and warning module is shared Switching Module and is connect with service sub-system. Integrate safety in production On-Line Dynamic Monitoring, alarming and managing, hidden troubles removing, intelligence law enforcement, emergency relief, specific aim, strong applicability, peace keyholed back plate is managed efficient.

A Chinese Patent No. CN109447048B granted on 25 Dec. 2020 titled “Artificial intelligence early warning system” provided an artificial intelligence early warning system which comprises an intelligent internet of things and risk factor data acquisition system, a risk factor management system, cloud computing, cloud storage, a cloud database, an artificial intelligence early warning operating system, an artificial intelligence early warning server, an internet plus distributed early warning kiosk, a five-level artificial intelligence early warning system, a four-level artificial intelligence early warning system, a three-level artificial intelligence early warning system, a two-level artificial intelligence early warning system and a one-level artificial intelligence early warning system. According to the invention, an artificial intelligent early warning system is used for collecting, contrastively analyzing, reasoning, evaluating, cloud computing, cloud storage, grading alarm and coping prevention and control on risk factors; the all-weather 24-hour monitoring on the peripheral control points of the police kiosk is realized, the information sharing can be realized for users.

### DESCRIPTION OF THE INVENTION

In the past, several methods and software have been defined for risk assessment. In most of these systems and software, the existing risk is statically examined and in order to prevent damage and also to reduce the damage caused by the events in accordance with the existing plant, the risks are identified and a protocol is defined for each case. At the time of the accident, whether analog or by utilization managers or digitally, and by the systems available on the site, the amount of risk is estimated and action is taken according to the existing instructions. In smarter structures, the software decides instead of the managers and based on the instructions in the database, the best protocol is selected from the system according to the incident and the system is created and the steps of implementing the mentioned protocol are started by the system and the necessary action are taken in accordance with the desired protocol. Mostly, these actions are unchangeable and the opening and closing of control valves as well as the activation of the fire extinguishing system or any other necessary action is done in sequence or on a scheduled or parallel basis.

Most of these protocols do not consider the manpower at the scene and also the location of machines and instruments as well as weather conditions are not affected the protocols at the moment.

Among the existing inventions in this field, which have made great progress in managing the risk of existing plants, we can mention the system provided by Honeywell, in which the presence of a processor connected to environmental sensors and device sensors can make the best required decision after receive related messages with each section and the necessary software commands are given to the hardware available on the site and the chain of actions is performed.

In the present invention, making decision and creating decision are presented together. In addition to the processing system, a new system has been added as a risk management system that at the time of the accident, by considering all available signals as well as control structures and environmental conditions, the presence of personnel and tools and the type of incident first reviews the available protocols and selects the best one by referring to the database central processing unit. Then, virtually and in the form of a simulation, it performs all operations once in its system and determines the performance results. If after simulating the risk reduction process, the amount of risk in the database is within acceptable limits, it allows the central processing system to implement the protocol. The presence of artificial intelligence helps to make a decision in this regard. In the event that none of the protocols in the database can reduce the level of risk, the risk management system begins to arrange the chain elements and build a new protocol to deal with risk, and when the chain of actions is complete, the protocol re-created in the server simulation system is executed and if the amount of risk is acceptable to the operation system is dictated and executed to the central processing unit.

The present invention, due to the fact that the server is equipped with software related to machine learning and artificial intelligence in each case, can store the created information as new protocols in the database and send it to the central processor under similar conditions for proper use. It is also possible that in normal times and without real events, the system constantly generates new risk and event information according to the elements in the line, and based on its hypothetical scenarios that are fully consistent with the site conditions and possible events, create this method and generate countless correct protocols and save according to the effectiveness of each.

Risk reduction measures are classified based on the reduction of probability and the reduction of the effects of the accident. The actions taken by the risk management unit will lead to risk management and reduction, and this management will lead to a reduction in the level of risk to approach an acceptable level.

In the storage tanks section, various detectors and cameras connected to the intelligent risk management system can be used to identify and manage the risk, to produce a protocol to reduce the risk effects in order to prevent personal and financial losses. The risk management department receives the information received from the detectors of the tank control section along with the information obtained from the cameras located in the workplace. Based on the input information, risk analysis and calculation is performed in 2D and 3D models.

First, the risk is identified and analyzed by this unit and the best scenario is selected by artificial intelligence. The necessary protection orders are then automatically issued separately for the tanks and staffs.

To protect and identify people in the tanks section and at the time of the accident, a series of data such as (detailed schedule of periodic repairs and technical inspection of each section, personal protection equipment of individuals in each section, how to use personal protective equipment correctly, etc.) stored in the data unit. This data is used in artificial intelligence to count, identify and monitor whether people are at risk.

For better realization of the subject matter, it is explained in the FIGS. 1 to 4) in detail.

Based on FIG. 1 this invention includes 3 main sections: work area (101), intelligent control and monitoring section (120) and risk management section (artificial intelligence) (121).

Section (101) includes work areas (102₁, 102₂) where storage tanks are located. These areas are equipped with various environmental sensors (smoke, temperature, direction and speed of wind, humidity, light, rain, lightning, gas leakage, etc.) (104₁, . . . 104₆). These sensors send information and instantaneous parameters to the tank control section (126) in the control and monitoring section based on artificial intelligence. In addition to the sensors inside the system, several cameras (109₁, . . . , 109₆) have been installed which in addition to monitoring assets (tanks and transmission lines, etc.), detects personal protection equipment (PPE) of each defined work area. Artificial intelligence-based face recognition cameras monitor people in each work area.

If people do not use or misuse personal protective equipment (PPE) and in case of entry of unauthorized persons into the work area, system will begin to warn. The camera information is sent instantly to the image scanning unit and then to the intelligent CPU (124).

There are loudspeakers (110₁,110₂), warning lights (105₁,105₂), safe points indicators, and boxes of personal protective equipment (108₁,108₂) for hazard and risk alerts. Fire extinguishing system and coolers are available (107₁, 1072) to prevent fire and explosion in the tanks.

Section (120) includes: data center (122), image scanning (123), central processing unit (124), archive (129), control room (128), artificial intelligence (125), and finally outputs which start to work at the time of identifying the danger (127).

Section (121) includes: sections on instantaneous parameters (121₁), risk analysis and evaluation (121₂), operational scenarios (121₃), selected scenario performance simulator (121₄), and data center (121₅).

The images taken by the cameras are first instantly entered into the image scanner (123) and after review and analysis by artificial intelligence, it is sent to the two risk management departments based on artificial intelligence (121) and the central processing unit (124). Simultaneously with the images, the sensor data is also transmitted through the section (126) to the risk management section (121).

Section (122) is the section of pre-determined data for the identification of persons, schedules for replacement of parts, periodic technical inspections, personal protective equipment (PPE) of each work area, the proper use of personal protective equipment and personal protective equipment at the time of accident. In the data section, all information for individuals is in separate files which include all workers face, heart beat and medical records.

In this section, by artificial intelligence-based risk management, we intend to predict the risk before the accident and manage to reduce the possible effects of risk in the storage tanks.

Images taken from tanks and individuals after being scanned in the image scanner (123) and the instantaneous information of the sensors are sent from the tank control unit (126) to the artificial intelligence based risk management unit (121). All instantaneous variables of sensors and cameras information first are sent to the instantaneous parameters (121₁). Then, in the risk analysis and evaluation section (121₂), risk analysis is performed in 2D and 3D. The risk calculation unit analyzes and calculates the probability and effects of the risk and reports the hazardous risks. After risk analysis the appropriate scenario is selected through artificial intelligence based on the probability and its effects in the operational scenarios section (121₂). In order to determine whether the selected operational scenario reduces the risk, it is sent to the operational simulator section of the selected scenario (121₄). In case of risk reduction, the selected operational scenario is sent to the data center (121₅) and central processing unit (124). The CPU starts working. It also issues the necessary notification orders through the output section (127).

The risk management system (121) automatically, after identifying the initial risk and reviewing the personal protective equipment (PPE) information, instructs to do the actions for preventing the accident and reduce its effects, and then instantly analyzes the initial risks, their effects and also secondary risks. Also it monitors all protection layers and process deviations momentarily.

For example, in the LPG gas storage tanks, in case of leakage, it is detected from the first moment through cameras and sensors, and the information sends to the risk management section based on artificial methods, and the risk of explosion and fire is quickly determined based on the available parameters (temperature, pressure, humidity, etc.) in the risk calculation unit and the amount of risk is analyzed. The results of risk analysis include three parts of risk (high, medium and low). If medium and high risk is identified after analysis, the appropriate scenario is selected through the operational scenarios in the data center. Then it is sent to the central processing unit section and this section gives the necessary order to different outputs.

Outputs include audio-visual warnings and indicators on the ground that guide people inside the plant to go to the safer areas from the safest route, to reduce the risk level to their lives.

They also according to the selected operational scenario, for example reduce the tank pressure. The tank outlet valve opens to transfer to another tank and other related actions are performed in the scenario.

Artificial intelligence based risk management department (121) in addition to controlling the accident tank and minimizing the risk, identifies other tanks and environments that will be endangered due to leakage, fire, etc. and analyzes their risk to save the entire tanks section.

Finally, the reasons for all alarms, accidents and images are stored in the archive section (129) so that at any time with a specific time and date it is possible to access to all plant information and when an incident occurred, the cause of the accident, images and data should be specified and accessible in the exact time and date.

FIG. 2 is a flowchart showing the safety steps of a plant based on image processing and artificial intelligence based risk management.
(201) generally, first cameras (109₁, . . . , 109₆) and sensors (104₁, . . . , 104₆) connected to the tank control section (126) identify images and information of workplaces (102₁, 102₂), tanks and individuals and sends them instantly to the risk management department (121) and the central processing unit (124).
(202) this step involves determining the current information from the images and sensor data.
(203) this step involves determining the minimum PPE requirements through data (122) in relation to each workplace based on risk management (121), at any time through the information from the data received from the tank control department (126) and scanned images (124) is sent to the risk management department (121) and the CPU department (124).
(204) analyzing sensors and image data, tanks risk management in case of leakage or accident is in 2D and 3D. In this way, it shows the concentration of the leaked gas, its direction of movement and the effective distance of the gas. If a leakage leads to a fire, the risk management section, based on the available parameters in the risk analysis and evaluation section in 2D and 3D of other involved tanks, analyze the flame orientation and temperature to reduce the risks and secondary risks caused by this accident.
(205) this step involves output operation through the central processing unit which this unit has received the necessary instructions through the artificial intelligence and risk management department.
(206) all information, operations, events, accidents and . . . with the exact date and time are recorded and stored in the archive section. So that they can be accessible whenever needed.

Based on FIG. 3, a schematic image of the hierarchy of information entry from one section to another in the risk management section based on artificial intelligence.

First, the scanned images of the cameras (123) and the received data of the tank control section (126) enter to the received instantaneous parameters section (environmental parameters) (121₁). After identification and preparation, it is sent to the risk analysis and evaluation section (121₂). In this section, the amount of risk is determined. If the risk is low, the information is sent to the data center (121₅). If the detected risk is high or medium, the information is sent to the operational scenario (121₃). The operational scenario section selects the risk scenario. The selected scenario is sent to the performance simulator section to investigate the scenario on the effect of risk. If the risk is reduced, it is sent to the data center to provide information to the CPU (124) for performance and output orders (127) in addition to storing the appropriate scenario and risk conditions.

According to FIG. 4 the risk management algorithm is based on artificial intelligence in order to control and protect the tanks and employees of this department.

The images of the cameras and the received data of the sensors of the tank control section are entered into the instantaneous parameters unit (121₁).

The information is then entered into the risk analysis and assessment unit for risk analysis and evaluation (122₂).

In this section, the amount of risk is evaluated, whether the risk is medium or high? If the risk is low, the information is stored in the data center. If the evaluated risk is medium or high, it is sent to the operational scenario section to select the appropriate scenario in related section by artificial intelligence algorithms. The information is then entered into the simulator (121₃). In this section, the simulator examines and analyzes the performance of the selected scenario.

If the selected operational scenario reduces the risk, it is sent to the CPU to start the operation to issue commands related to the scenario and the performance of the tanks (121₄). It is also stored in the data center (121₅). If the scenario does not reduce the risk, it referred back to the selection of the appropriate scenario in the operational scenario section by artificial intelligence algorithms.

### BRIEF DESCRIPTION OF FIGURES

FIG. 1: A schematic image of the staffs system, device safety, and risk management based on artificial intelligence through the processing of multiple images and information in storage tanks during operation.

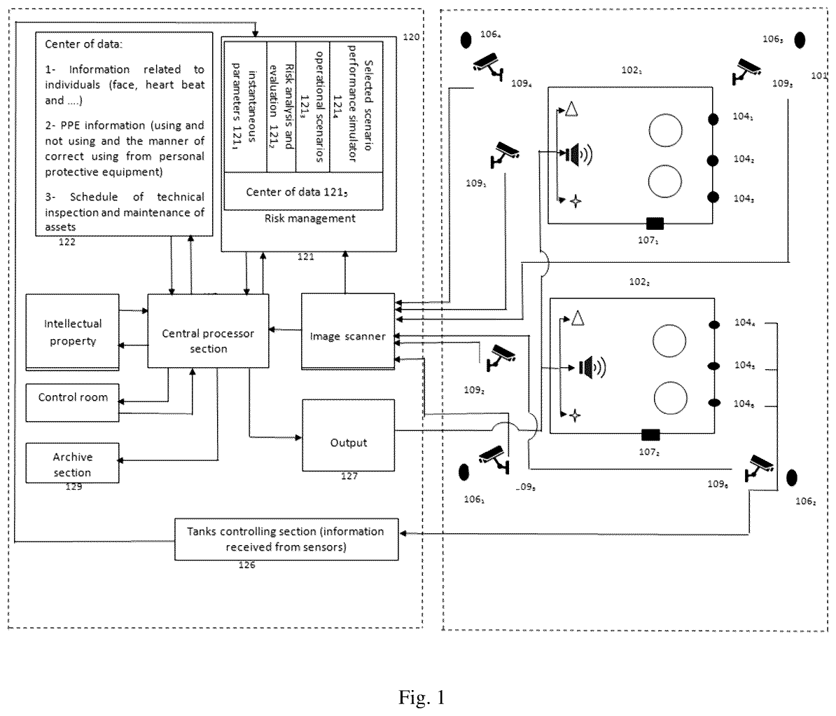

FIG. 2: A flowchart according to which the stages of risk management and plant safety system based on artificial intelligence and image processing has been shown.

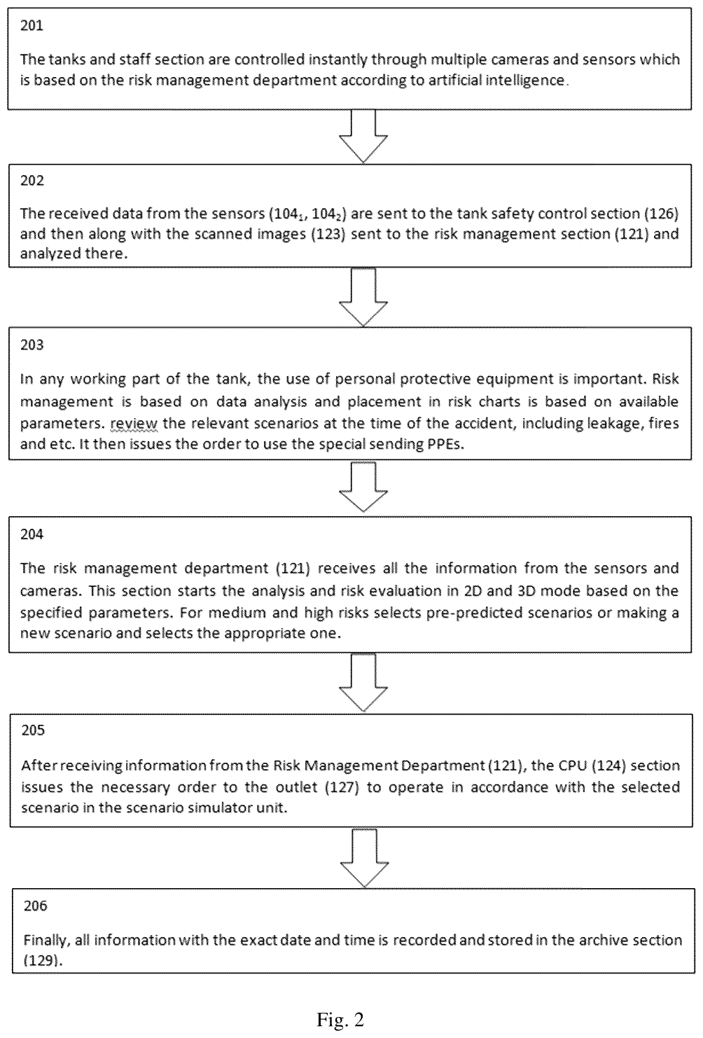

FIG. 3: A schematic image of the risk management section based on artificial intelligence and how they relate to each other.

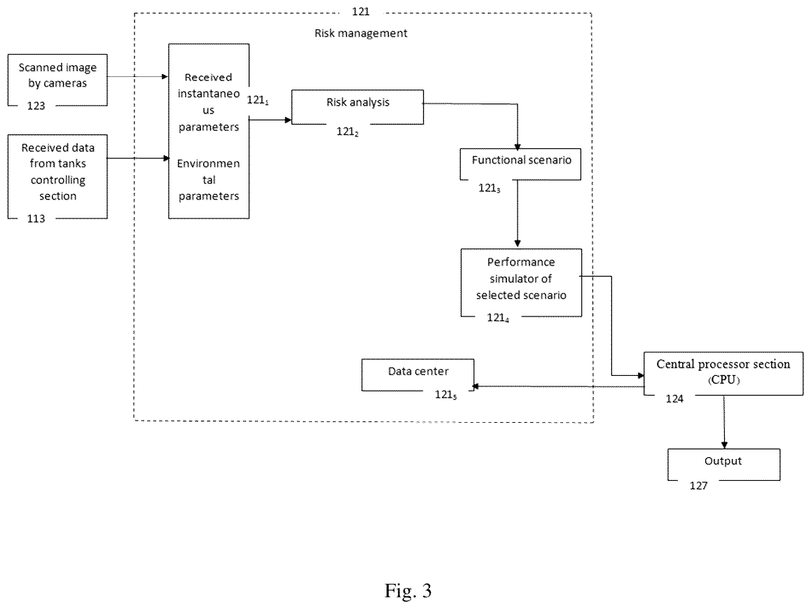

FIG. 4: A risk management algorithm that describes how the risk management department works based on artificial intelligence.

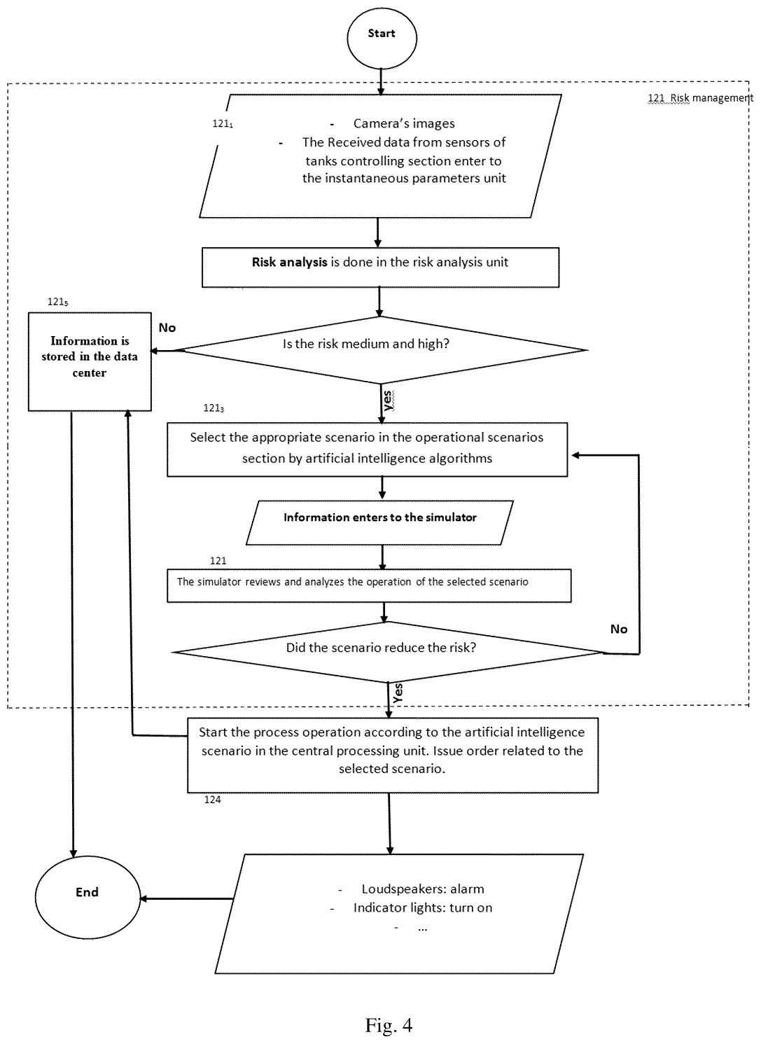

What is claimed is:

1. The invention system and method for making risk reduction protocol in oil and gas industry tanks based on risk management in the form of artificial intelligence includes at least one data collection structure for environmental sensors and equipment sensors and at least one system for collecting and processing images of ambient cameras and cameras mounted on or inside the equipment to collect image information and at least one processor wire for data analysis of sensors and cameras, and at least one database for maintaining information and maintaining risk reduction protocols, and at least one separate system for processing protocols and simulating events and risk reduction protocols for decision making and at least one artificial intelligence structure to review and analyze the information received and analyze the results of the server simulation system and help make the final decision or decision to generate a new protocol, as well as to create virtual events and generate new protocols and simulate and determine the results of its implementation.

2. System and method of claim 1 in which there is a system for implementing the risk reduction protocol in the server and analyzing the results of the implementation of the protocol before sending orders to different parts of the plant, which can check and analyze the protocols in the database at the time of risk and can implement the proposed and built-in new protocols in the present invention virtually and analyze the results.

3. System and method of claim 1 which in the risk management section, after implementing the protocols in the system database and their ineffectiveness or lack of acceptable risk reduction based on the defined elements, can define a chain of actions one after another in a way that results in creating a new protocol.

4. System and method of claim 1 which can diagnose, analyze and evaluate the risk before the accident.

5. System and method of claim 1 in which artificial intelligence can act as risk reduction management at the time of the accident and reduce human errors.

6. System and method of claim 1 in which prediction of risk and its probable effects by simulator and preventing secondary risks in safety operation of tanks is provided.

7. System and method of claim 1 in which reviewing instantaneous variable parameters in developing the accident and 2D and 3D analysis of risk before occurring the same is one of important part of this invention.

8. System and method of claim 1 in which calculation of risk and selection of scenario for continuously risk reduction until controlling and removing the risk and registering the required action for compensating the probable effects till removing the risk is from features of this invention.

9. System and method of claim 1 in which risk management and selection of scenario for removing secondary risks by analyzing the simulator and artificial intelligence and bringing the tanks to the safety operation mode is from features of this invention.

10. System and method of claim 1 in which guidance and management of human resources before the accident for preserving the individuals life is from features of this invention.

11. System and method of claim 1 in which management of equipments, resources and process and tanks for safety and preserving asset before accident is from features of this invention.

12. System and method of claim 1 in which making selected scenario or combinations of scenarios for reduction of high risks to neutral or safe area is from features of this invention.

13. System and method of claim 1 in which the possibility to send the operational scenarios through risk management unit to central controlling system and receiving process operation response for risk management is from features of this invention.

14. System and method of claim 1 in which the possibility to simultaneously analyze the different scenarios based on the various parameters and selecting and making the best scenario and analyzing it for reduction of risk is from features of this invention so in case of leakage in the tanks and chemical contaminations and explosion thereof simultaneously, analyze the effects of different scenarios and select the best operation for reduction of risk.
